(19) United States
(12) Patent Application Publication
(10) Pub. No.: US 2014/0164046 A1
(43) Pub. Date: Jun. 12, 2014

(54) INTEGRATED FOOD AND BEVERAGE MANAGEMENT, INVENTORY AND DISTRIBUTION SYSTEM

(71) Applicant: Catalyst Collective Partners, LLC, (US)

(72) Inventors: Anthony Haralambos, San Marino, CA (US); Burke H. Eiteljorg, Santa Monica, CA (US); Edward S. Wunsch, Boulder, CO (US)

(73) Assignee: Catalyst Collective Partners, LLC

(21) Appl. No.: 13/829,659

(22) Filed: Mar. 14, 2013

Related U.S. Application Data
(60) Provisional application No. 61/661,911, filed on Jun. 20, 2012.

(51) Int. Cl. G06Q 10/06; G06Q 30/06; G06Q 30/02

(52) U.S. Cl. CPC G06Q 10/06315; G06Q 30/0226; G06Q 30/0631
USPC 705/7.25

(57) ABSTRACT

A method and system for ordering a food or beverage from an on-site inventory local to a food and beverage customer via a graphical user interface and a network is provided. The on-site inventory is associated with at least one off-site inventory. The method includes providing a user interface to a purchaser, wherein the user interface is capable of displaying at least a portion of the on-site inventory to the purchaser. The method also includes receiving instructions from the purchaser via the interface relating to the selection of a first food and beverage from the on-site inventory, delivering the first food or beverage from the on-site inventory to the purchaser, accounting for the cost of the first food or beverage with the purchaser, and determining whether the on-site inventory quantity of food or beverages of the first food or beverages is below a pre-determined minimum quantity. The method also includes the automatic generation of a draft renewal order for transmittal to one or more pre-determined distributors of a sufficient quantity of the first food or beverage to replenish the on-site inventory quantity above the minimum.

### RELATED APPLICATIONS

This application claims priority to U.S. provisional application Ser. No. 61/661,911 filed Jun. 20, 2012, the disclosure of which is incorporated by reference herein in its entirety.

### BACKGROUND OF THE INVENTION

1. Field of the Invention

The present invention relates generally to beverage and food customer management, sales, distribution, retailing, and supplying. In particular, the present invention relates to a network based system and method for customer management, sales, distributing, supplying, tracking, inventory, ordering, reporting, recommendations, serving, communications, and loyalty related to beverages and food.

2. Description of the Related Art

From the perspective of a beverage and food customer, the conventional method of ordering or purchasing one or more servings of beverages or food at a restaurant or retail location involves many steps that, while traditional and methodological, are generally inefficient for the customer and the restaurant and the retailer. This is especially true for restaurants and retailers that provide specialized food or beverage services and a voluminous food or beverage inventory.

For example, when a typical customer decides to order a bottle of wine with a meal at a restaurant, they review a printed wine list and determine which wine or wines may be best to accompany the meal. The customer customarily takes into account parameters in choosing the wine, such as, inter alia, the food that will be consumed with the wine, the culture of the cuisine, the customer's general taste or origin preferences for the wine, and the wine's price.

A customer's wine choice during an ordering session also depends significantly on the expertise of the particular customer and the amount of money the customer is willing to spend. A customer typically chooses a particular bottle of wine after evaluating all of these parameters and more. Oftentimes, after a customer chooses a particular bottle from a printed wine list, the wine server may come back from his cellar and inform the customer that the particular bottle that he or she ordered is no longer in stock. This results in the customer having to interrupt his restaurant experience to re-evaluate the list and these parameters, and choose another wine, all while not being entirely sure that the wine he or she is choosing is in stock. For lengthier wine lists and more expert wine customers, this can be a tedious and annoying process.

On the other end of the spectrum, beverage and food customers that do not have expertise in ordering wines may ask for assistance from the sommelier or may otherwise be unsure of what wine is best matched with the restaurant's particular cuisine. Viewing even a simple wine list, which typically shows only names, types and prices, may result in a guessing game as to which wine to choose. This of course also may result in mismatched wines, wines that do not otherwise enhance food to the fullest extent possible and other intimidations.

Some restaurants, vendors and retailers have begun to offer electronic food and beverage services to the customer, wherein handheld computer displays such as tablet computers or iPad® devices may facilitate the beverage or food sales and ordering process. These devices offer a graphical user interface that allows for an updated listing of the beverages and food that are available in the restaurant. The devices also facilitate searching for food or beverages, which allows for more efficient searching for recorded beverage and food preferences.

These electronic dinning guides can be updated automatically to reflect the present beverage and food inventory in the restaurant, thereby alleviating some of the problems with traditional beverage and food sales. However, electronic beverage and food guides are often networked only with a limited service either within the single location or a limited network of other restaurants and retailers. For the most part, these electronic devices are limited to static displays that do not display other information that might be usable to a customer, a restaurant, distributor, or supplier.

### SUMMARY OF THE INVENTION

To address one or more shortcomings of the prior art, in one aspect of the invention a customer management system is provided for sales, distribution and supplying integrating customer information including sales, tracking, demographics, behaviors, and predicted future ordering and behavior preferences; and inventory management, feedback, ratings, communications and loyalty. The system includes a host operator interfacing with a host computer including at least one user interface and at least one network interface, and a plurality of distributors and customers in communication with the host operator via a network. Each of the distributors is capable of assembling and transferring a quantity of beverages and food from one or more distributors' inventories. The system also includes at least one supplier in communication with the host operator via the network, wherein the supplier is capable of assembling and transferring a quantity of beverages and food from one or more respective inventories. In addition, the system includes a plurality of restaurants and retailers in communication with the host operator via the network, wherein each of the restaurants or retailers implements at least one terminal computer. The system also includes software running on the host computer to allow the plurality of restaurants and retailers to order quantities of beverages and/or food from the plurality of distributors or suppliers via the user interface for transfer of the beverage and/or food from the distributors or suppliers to the retailers.

In another aspect of the invention, a method for ordering beverages or food from an on-site inventory is provided to a customer via a graphical user interface and a network. The on-site inventory is associated with at least one off-site inventory. The method includes providing a user interface to a customer or purchaser, wherein the user interface is capable of displaying at least a portion of the on-site inventory to the customer. The method also includes receiving instructions from the customer via the interface relating to the selection of a first beverage or food from the on-site inventory, delivering the first beverage or food from the on-site inventory to the customer, accounting for the cost of the first beverage or food with the customer, and determining whether the on-site inventory quantity of beverage or food of the first beverage or food is below a pre-determined minimum quantity. The method also includes the automatic generation of a draft renewal order for transmittal to one or more pre-determined distributors or suppliers of a sufficient quantity of beverage or food to replenish the on-site inventory quantity above the minimum.

In yet another aspect of the invention, a user interface for ordering beverage or food by a customer is provided that includes a graphical identifier to allow a user of the interface to log into a user account associated with the customer, and a screen showing a pre-determined selection of beverage or food, that could combine beverage or food pairings and categories, based upon user ordering preferences (liked or not liked).

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a schematic overview of detailed aspects of the system and method in accordance with one embodiment described in the disclosure herein;

FIG. 2 is a schematic diagram of the network used in association with the embodiment of FIG. 1;

FIG. 3 is a representation of a user interface screen for use by customers in association with the system shown in the above Figures;

FIG. 4. is a representation of an inventory management screen for use by restaurants and retailers in association with the system shown in the above Figures;

FIG. 5 is a representation of an inventory management and distributor ordering screen for use by restaurants and retailers in association with the system shown in the above Figures;

FIG. 6 is a representation of a distributor order management screen for use by distributors in association with the system shown in the above Figures;

FIG. 7 is a representation of a distributor inventory management and supplier ordering screen for use by distributors in association with the system shown in the above Figures;

FIG. 8 is a representation of a supplier inventory management and distributor ordering screen for use by suppliers in association with the system shown in the above Figures;

FIG. 9 is a representation of a supplier inventory and product management screen for use by suppliers in association with the system shown in the above Figures;

FIG. 10 is a representation of another embodiment of a user interface screen for use in association with the system shown in the above Figures;

FIG. 11 is a representation of another embodiment of a user interface screen for customers to search and identify food and beverages in a restaurant, retailer, distributor or suppliers inventory use in association with the system shown in the above Figures;

FIG. 12 is a representation of another embodiment of a user interface screen for customer account management and service access in association with the system shown in the above Figures;

FIG. 13 is a representation of another embodiment of a user interface screen for restaurants, retailers, distributors and suppliers to view customer information and access inventory recommendations in association with the system shown in the above Figures;

FIG. 14 is a schematic diagram showing rating processes of various products;

FIG. 15 is a flow diagram illustrating the compilation of user expertise values as described in the disclosure herein;

FIG. 16 is a schematic diagram illustrating factors relating to the collection of loyalty points in accordance with the disclosed method herein; and

FIG. 17 is a schematic diagram illustrating factors relating to the communication and sharing of information between all parties in accordance with the disclosed method herein.

### DETAILED DESCRIPTION OF THE PREFERRED EMBODIMENTS

Disclosed herein is a system and associated methods for ordering consumable products, such as food and beverages. Using the system and the methods herein, users, purchasers, distributors, suppliers, restaurants, and retailers can take advantage of a network that is customized to the needs of the unique product. With respect to wines, the distribution of which must be strictly controlled due to wine's unique value, perishability, and demand, retailers such as restaurants must keep close watch on their inventories to ensure that purchasers can buy wines when desired.

The embodiments of the inventions disclosed herein are primarily associated with the ordering, selection, storing and purchase of individual food or beverage quantities. Of course, the present invention could be associated with other consumable products, and the present embodiments are only exemplary.

It should be noted that for purposes of the present disclosure, the term “beverage” and “food” will have their ordinary meanings, although reference to foods or beverages in general is meant to convey, for example and without any limitation, any product, such as a consumable product that may be consumed by a person. For convenience throughout this disclosure, the term “consumable product” may be substituted for the above items.

In general, the distribution of food and beverage for retail sale by restaurants and retailers involve three primary acting entities: 1) suppliers (also referred to wineries, distilleries, breweries or producers); 2) distributors; 3) retailers and restaurants; and 4) individual purchasers.

Ordering by purchasers (sometimes referred to as “users”) at restaurants (sometimes referred to herein as “retailers”) occurs when a purchaser buys a food or beverage at a restaurant or retailers. The restaurant and retailer has its own local inventory from which the purchaser can choose. The supply chain used to replenish and supply inventory at these restaurants and retailers in most cases is populated by local and even foreign food or beverage distributors or suppliers. The distributors may in turn be supplied by suppliers or other conglomerate suppliers. The supply chain can also be populated by individual suppliers that specialize in making food and beverages, and delivering particular food or beverage products directly to restaurants, retailers, distributors, and customers. Other potential supply chain suppliers can also be rare food or beverage collectors, purchase groups, private cellars or even other restaurants.

A customer or customers herein may be one customer, one consumer, a plurality of consumers, a plurality of consumers or combinations of at least one customer and at least one consumer.

A communication system is utilized by the restaurant, retailer, manufacturer or third-party (such as a brand) to directly communicate with the customer with an offer to purchase food or beverages that relate to customer purchases and preferences that occurred in the restaurant, retailer, distributor, or supplier network. The communications may be targeted to specific customer(s) according to data captured in the network such as demographics, behaviors, purchases, visits, preferences, loyalty status, and location.

A communication system is utilized by the restaurant, retailer, supplier or third-party (such as a brand) to directly communicate with the customer with an incentive to re-purchase food or beverages or re-visit a restaurant or retailer that relates to customer purchases and preferences, and visits that occurred in the restaurant, retailer, distributor, or supplier network. The communications may be targeted to specific customer(s) according to data captured in the network such as demographics, behaviors, purchases, visits, preferences, loyalty status, and location.

In a first embodiment herein, the close network of suppliers (distributors and suppliers), restaurants, retailers and users may be managed by a central server and system which can be used to monitor and coordinate sales and customer relationships if necessary.

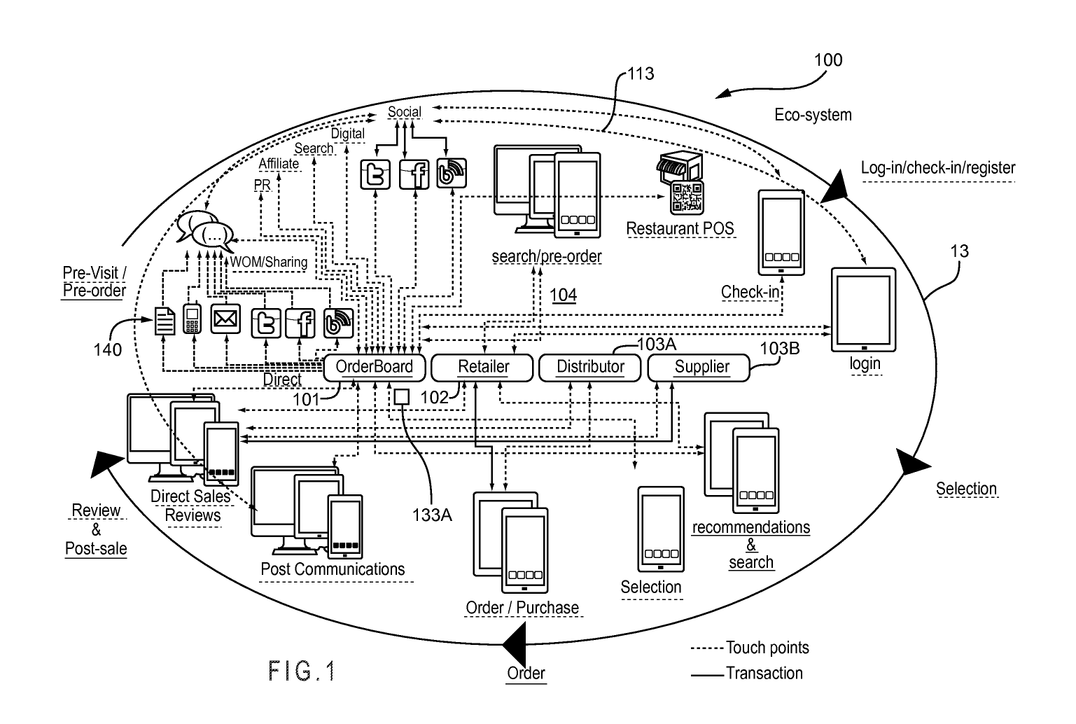

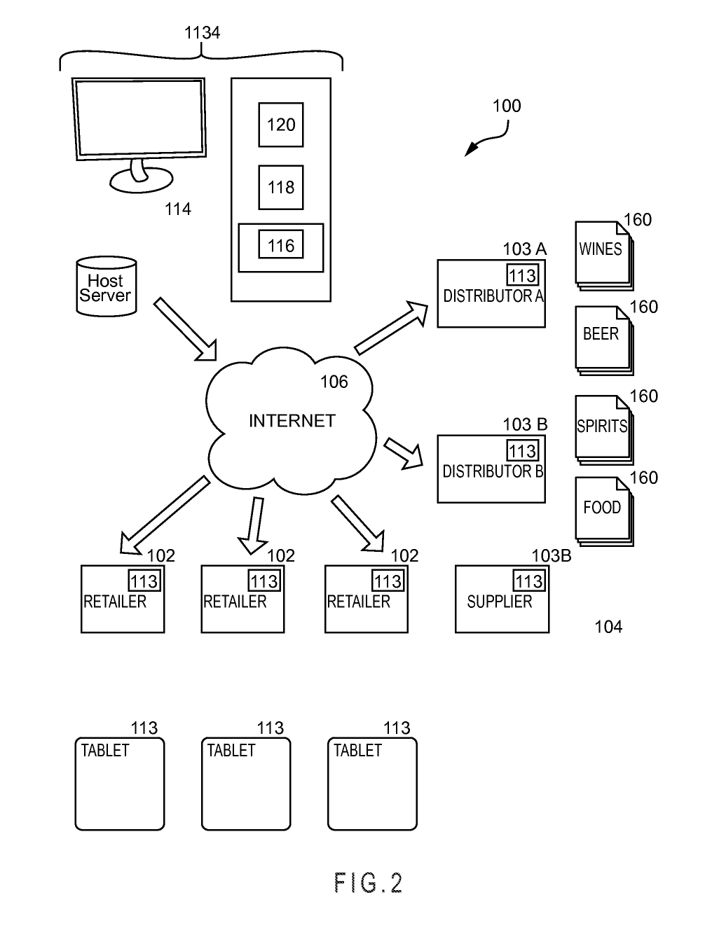

Turning now to the drawings, an exemplary diagram of such an embodiment is illustrated by the schematic diagram of FIG. 1. As shown in the diagram, the system 100 comprises a host operator 101. The host operator 101 manages the system. It may add/delete system users, manage and control various levels of system accesses, add new features, and/or enhance existing functionalities of the system 100. The host operator 101 may also maintain the system 100 by determining where, when and how the system 101 may operate. The host operator 101 is associated with a plurality of retailers, such as restaurants 102, distributors 103A, and suppliers 103B. These main users of the system are connected via hardwired or wireless network connections 130, which may also comprise connections to the Internet as shown below in FIG. 2. Together, the systems comprise the network 104.

Also associated with the network 104 of the system 100 are a plurality of computers 113 which may be used to interface with the network 104 at various points in the disclosed method, and at various locations.

The computer 113 (and associated computers such as host computer 113A) and the term “computer” as used throughout this disclosure herein may be a computing device which allows a user to connect to a network 104, such as the Internet. The computer 113 preferably runs software that implements the various steps and methods disclosed herein. Examples of the computer 113 include, but are not limited to, a personal computer, personal digital assistant (“PDA”), a laptop, a smartphone, a cellular phone, a tablet, or other electronic device. The computer 113 may include an interface 114, software 116, memory 118, and a processor 120.

The processor 120 in the computer 113 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with the memory 118, or the memory 118 may be a separate component. The memory 118 stores data. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded advertisement (“ad”) or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The interface 114 may be a user input device or a display. The interface 114 may include a keyboard, keypad or a cursor control device, such as a mouse, or a joystick, touch screen display, remote control or any other device operative to allow a user to interact with the computer 113. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120 or the results of the data analysis. In particular, the interface 114 may allow a user to interact with the computer 113 to administer software running the methods disclosed herein. Furthermore, as noted previously, tablet computers, mobile phones or other handheld devices may be used as the network host or the computer 113.

The present disclosure contemplates a computer-readable medium that maybe non-transitory and may include instructions or receive and execute instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly or via the Internet.

Any of the components in the system 100 may be coupled with one another through a network, including but not limited to the network 104. For example, the Computer 113 may be coupled with similar computers run by other nodes in the network such as the distributors and the retailers through the Internet 106 as shown. Accordingly, any of the components in the system 100 may include communication ports configured to connect with a network.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Preferably, the primary capabilities of the network 104 are implemented in hosting software running on a host computer 113A. The features of the software implement the methods described further herein, and may also run software modules to allow for various forms of communication shown at 140 including social media interaction, posting on various websites, text messaging, email, calling, and even fax.

Each system user may be authenticated via standard username and password means, allowing for at least three levels of secure access to the network 104. One level of access is for administrators to the system 100 to operate directly on the host computer 113A. A second level of access is for distributors, suppliers, retailers and restaurants to access information regarding their individual customer records, sales records, communication records, and inventories. Finally, the third level allows access by individual purchasers of food and beverages at retailers such as restaurants. Typically, this third level of access allows individual users to access profile data, recommendations and even a customized user interface based on that user's preferences.

The system allows for customers, restaurants, retailers, and suppliers to share beverage and food purchased or reviews and restaurant and retailer visit information through communication vehicles and social networks with other customers, restaurants, retailers, and suppliers.

FIG. 2 is a higher-level illustration of the main operating components of the system 100. The system 100 includes the host computer 113A, preferably running at or in association with the host operator 101 of FIG. 1. A plurality of distributors 103A is shown to include Distributor A and Distributor B. Each of the distributors 103A includes a stock quantity of food or beverages contained within associated distributor inventories 160. For purposes of this disclosure, suppliers 103B may be considered similar to a distributor of food or beverages from many brands, but instead focusing on a smaller quantity of self-crafted, manufactured or chosen food and beverages. Each of the distributors 103A and suppliers 103B preferably operate at least one computer 113, which is in communication with the host computer 113A via the Internet 106.

Numerous individual users may interact with the system 100 via retailers 102. Each individual retailer preferably operates one or more wirelessly networked computers 113, such as tablets or other handheld devices. Each of the retailers 102, in turn, operates an individual computer which may access the Internet 106, and in turn access information and receive commands from the host computer 113A.

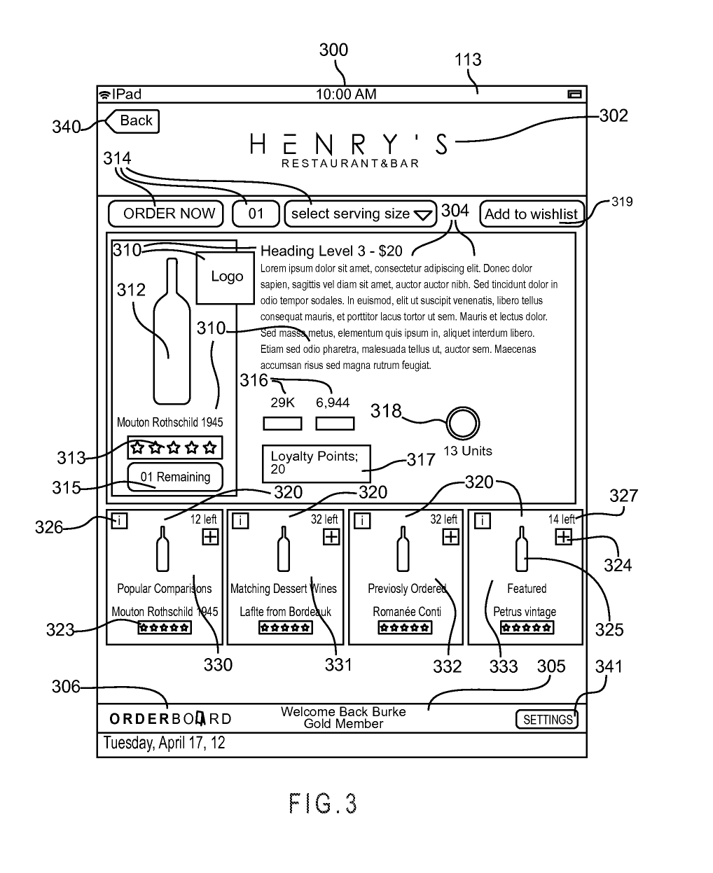

An example of an embodiment of an individual user interface on one of the computers 113 used for restaurant food or beverage purchases at a retailer 102 is shown in FIG. 3. For this example, the computer 113 is a tablet device such as an Apple iPad®, showing user interface 300, and the retailer is a restaurant. As shown in the Figure, the interface 300 is fully customized so that the restaurant or retailer's logo and name may be shown in the header 302 of the page. The restaurant or retailer's customer can log in to the interface screen 300 and preferences and other information will be read from the user's account residing on the system 100 such as the memory 118 of the host computer 113A. Based on the user account information and preferences, the screen will be customized to display the user's name 305, and a membership level or ranking 306. The system and method herein allow users the ability to customize their user interface based on a variety of factors to ensure that the user experience is helpful and efficient during the food or beverage ordering process.

The user account information will also inform the display of the interface 300 via the methods described further below. In this example, a selection of food or beverage is displayed, including a selected food or beverage and an icon or photo of the particular food or beverage 312. Each food or beverage will include information 310 on the food or beverage, such as a headline, description, review, logo, or other information. Other information associated with the particular food or beverage 304 can also be displayed, such as the rating 313, inventory level 315, sharing and other customer reported information 316 which may include reviews, loyalty points 317, and expert advice 318, which can all be based on various factors described further herein. An “add to” wish list icon 319 that places the product in a user's account to access for easy access and potential future ordering may also be included. Finally, an icon 314 may be presented to allow the user the option of ordering or purchasing quantities and serving sizes of this particular food or beverage 304.

Other food and beverage recommendations may be added at 320 including but not limited to comparisons 330, matching 331, previously ordered 332, and featured 333. Rating graphics 323, order icons 324, item icons or photos 312, information icons 326, inventory remaining 327, may be displayed in accordance with other information stored on the system 100 for each particular displayed food or beverage. The food or beverage recommendations for a particular user are determined based on various parameters, described further herein.

Finally, the interface 300 may include various navigational icons 340 to allow the user to manipulate the display by scrolling or otherwise progressing through a pre-determined, customized food and beverage list as well as access setting icons 341 for access to user account information, ordering information, recommendation information, loyalty information and other information.

Elements such as rankings, loyalty values, user experience and taste ratings, other customers with similarly determined rankings and ratings, expert guidance and program rankings and ratings (for example a recognized sommelier, chef, weight loss program, health program, allergy avoidance program, or nutrition program), geographic proximity, geographic association to other geographic locations, and restaurant, retailer and supplier types could be manually adjusted by the customer or automatically delivered to the customers. These recommendations may be enhanced through neural network and artificial intelligence algorithms with proprietary variable settings across all captured data in the network including other customer, retailer, restaurant, distributor and supplier preferences and history. The manual or automatic recommendations may be utilized across the network or targeted to specific location(s). The benefit of this pre-determined selection of food and beverages for customers is a quicker, simpler and more effective method for ordering or purchasing food or beverages that align with the customer's identified preferences.

The system also allows a customer to pre-order food or beverages. For example, a customer can view the food and beverage inventory or menu of a restaurant, retailer, distributor or supplier and pre-select or purchase a food or beverage, or a combination of food and beverages before visiting the location. This allows the restaurant, retailers, distributor or supplier to ensure that the food or beverages are in-stock during the customer's visit, allows them to pre-prepare items such as wine that needs time to adjust to temperature differences and air exposure, and makes pre-selections for parties to help improve the customer experience.

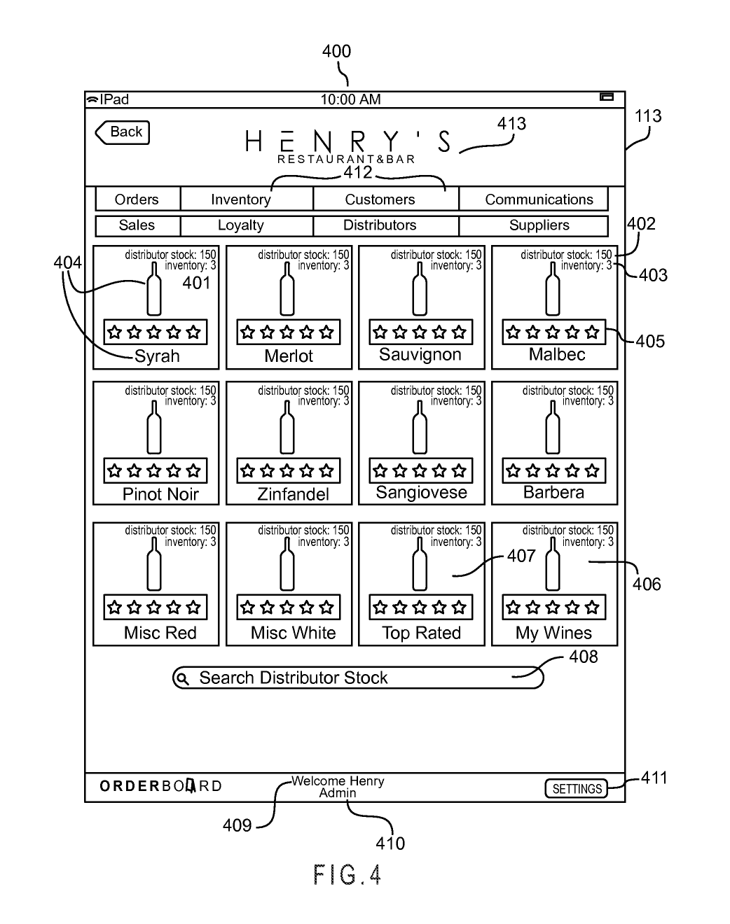

FIG. 4 shows a second embodiment of a user interface 400 implemented on a tablet computer 113. This version of the interface is customized for inventory management by restaurants and retailers. As shown in the Figure, the interface 400 is fully customized so that the restaurant or retailer's logo and name may be shown in the header 413 of the page. The restaurant or retailer's employee can log in to the interface screen 400 and the system will need preferences and other information from the user's account residing on the system 100 in the memory 118 of the host computer 113A. Based on the user account information and preferences, the screen will be customized to display the user's name 409 and an account access level or responsibility designation 410. The system and method herein provides users the ability to customize their user interface based on a variety of factors to ensure that the user experience is helpful and efficient during the food or beverage inventory management process.

The user account information will also inform the display of the interface 400 via the methods described further below. In this example, a selection of categories 401 are displayed for wine. Each food or beverage category 401 will include information 404 on the food or beverage category, such as an icon or photo, headline, description, review, or other information. Other information associated with the particular food or beverage category 401 can also be displayed, such as the rating 405, local inventory level 403, and distributor inventory level 402 which can all be based on various factors described further herein. The user also has the ability to add customized categories such as Top Rated 407, My Wines 406, Top Sellers, Best Trending, New Offerings, Sommelier Network Picks, Organics, Diet Program Picks, Domestic, Italian, etc. to the customized category displays. These customized adjustments can be accessed through the Settings button 411. Finally, a user can search distributor stock 408.

Finally, the interface 400 may include various navigational buttons and icons 412 allowing the user to manipulate the display, scroll or otherwise progress through pre-determined areas of the application such as Back, Home, Orders, Inventory, Sales, Customers, Communications, Loyalty, Distributors, Account, Settings, Ratings, etc.

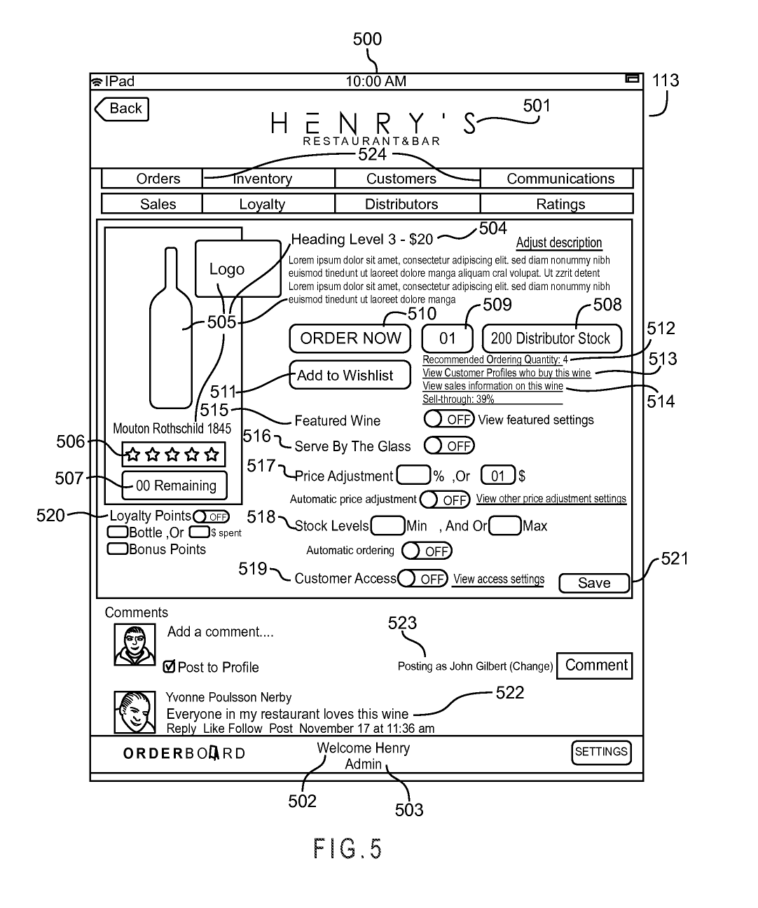

FIG. 5 shows a third embodiment of a user interface 500 implemented on a tablet computer 113. This interface is customized for use by the restaurant and retailers to manage and order inventory. Here, the restaurant and retailer can manage items in their inventory including description, featured settings, serving options settings, price adjustment settings, stock level settings, customer access settings, loyalty point settings, as well as place orders to distributors and suppliers and adjust settings for the item being ordered, view content to help them better manage and order including recommended ordering quantities, view customer profiles who buy this item, sales history of this item, and read and share comments about this food or beverage. As shown in FIG. 5, the interface 500 is fully customized so that the restaurant's or retailer's logo and name may be shown in the header 501 of the page. The restaurant or retailer's user (employee) can log in to the interface screen 500 and preferences and other information will be read from the user's account residing on the system 100 such as the memory 118 of the host computer 113A. Based on the user account information and preferences, the screen will be customized to display the user's name 502 and an account access level or responsibility designation 503. The system and method herein allows users the ability to customize their user interface based on a variety of factors to ensure that the user experience is helpful and efficient during the food or beverage inventory management and ordering process.

The user account information will also inform the display of the interface 500 via the methods described further below. In this example, a selected of food or beverage 504 is displayed. But it is noted that any food or beverage could be displayed using this interface. Each food or beverage selected 504 will include information 505 on the selected food or beverage, such as an icon or photo, headline, description, or review. Other information associated with the particular food or beverage 504 can also be displayed, such as the rating 506, local inventory level 507, and distributor inventory level 508 which can all be based on various factors described further herein. In association with the selected item 504 the user also has the ability to adjust order quantity 509, place the order 510, add to wish list 511 for simple future references or view recommended ordering quantities 512. These options can all be based on various sales, customer, inventory levels and other network tracked factors described further herein. The user can also view profiles of customers who buy this wine 513, which can be based on various factors described further herein, view sales of this wine 514, select if it will be a featured wine 515. Furthermore, the user can access featured settings including the ability to turn features on or off, bid on featured listing prioritization, select the serving type of the wine 516, which may be based on various factors described further herein including food and beverage being ordered, select and adjust the price 517 by percentage markup or dollar markup, select if price will be automatically adjusted if the distributor changes the price, view other price adjustment settings based on various factors described further herein such as time, customer, loyalty level, customer type, value, and quantity, select and adjust stock levels 518 including minimum and maximum inventory levels, automatically order from the distributor based on various factors described further herein, select customer access 519 and adjust settings that include limiting the sale of an item to defined customer(s) based on characteristics such as a customer value, customer sales, and customer loyalty, select and adjust loyalty points 520 earned with the purchase including points earned by the purchase of the bottle, per dollar spent on the bottle, bonus points earned with the purchase of this bottle, and save 521 changes that were adjusted by user. Finally, a user can view other postings 522 about this food or beverage from customers, distributors, suppliers, or other restaurants and retailers, and post their own comments 523.

Finally, the interface 500 may include various navigational buttons and icons 524 to allow the user to manipulate the display, scroll or otherwise progress through pre-determined areas of the application such as Back, Home, Orders, Inventory, Sales, Customers, Communications, Loyalty, Distributors, Account, Settings, Ratings, etc.

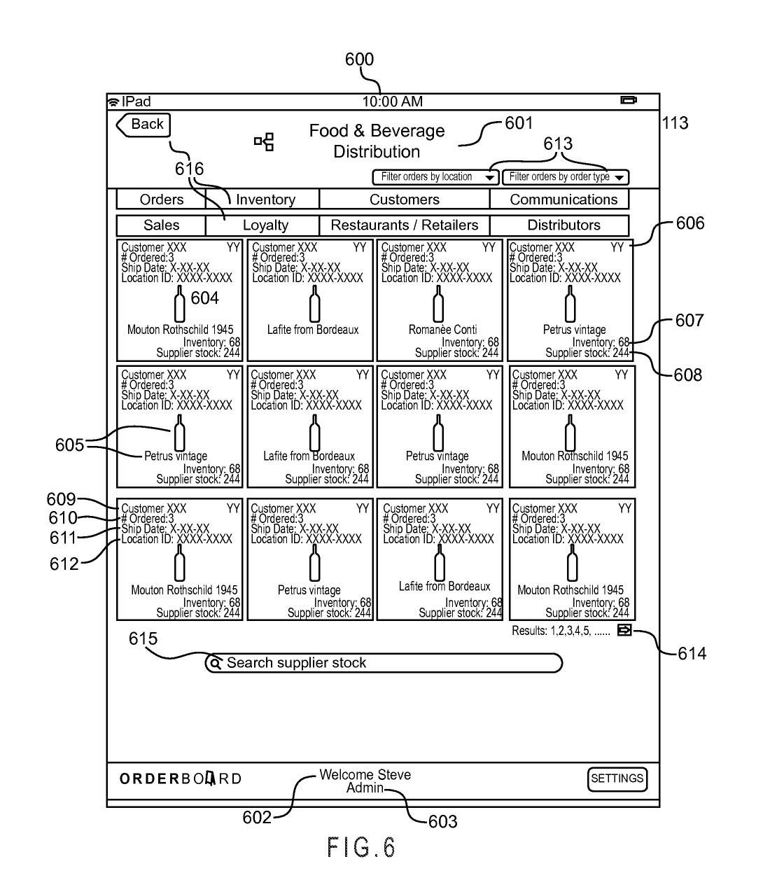

FIG. 6 shows a fourth embodiment of a user interface 600 running on a tablet computer 113. This interface is customized for use by a food and beverage distributor to manage orders from retailers such as restaurants similar to that shown in FIG. 4. Here, the distributor can manage orders, view its particular inventory of food and beverages, and make shipments to customers (the retailers) via a customized set of icons. Similarly, FIG. 6 illustrates a user interface 600 customized for a supplier, wherein the tablet computer 113 may be used by the supplier to track orders, view inventory and make shipments. As shown in FIG. 6, the interface 600 is fully customized so that the distributor's logo and name may be shown in the header 601 of the page. The distributor user (employee) can log in to the interface screen 600 and preferences and other information will be read from the user's account residing on the system 100 such as the memory 118 of the host computer 113A. Based on the user account information and preferences, the screen will be customized to display the user's name 602, and an account access level or responsibility designation 603. The system and method herein allow users the ability to customize their user interface based on a variety of factors to ensure that the user experience is helpful and efficient during the food or beverage ordering and inventory management process.

The user account information will also inform the display of the interface 600 via the methods described further below. In this example, a selection of food or beverage orders 604 is displayed. Each food or beverage order 604 includes information 605 on the food or beverage such as an icon or photo, headline, description, or other information. Other information associated with the particular food or beverage order 604 can also be displayed, such as the order ID 606, local inventory level 607, supplier inventory level 608, Customer name or ID 609, Quantity Ordered 610, Ship Date 611, and Location ID 612 that can be associated to the distributor's infrastructure or restaurants and retailers defined geographic identifier. Finally, the user can access search tools to filter 613 order results by geographic location, order type, order value, customer type, customer, product type, product value, sales rep location, sales rep, and product ID, and navigate 614 through results returned from the selected search criteria, or search the supplier's inventory.

Finally, the interface 600 may include various navigational buttons and icons 616 to allow the user to manipulate the display, scroll or otherwise progress through a pre-determined areas of the application such as Back, Home, Orders, Inventory, Sales, Customers, Communications, Loyalty, Suppliers, Restaurants and Retailers, Account, Settings, Ratings, etc.

The application can also recognize geographic location to activate automatic services associated with the location such as automatic login to the restaurant or retailer, loading the local restaurant and retailer menu and local on-site inventory download, and social media updates.

The system allows the restaurant and retailer to manually or automatically adjust prices of the food or beverage presented to the customer depending on defined characteristics such as time, identified restaurants, retailers, distributors and customers, menu pairings, product pairings, and location. This allows restaurants or retailers to achieve higher sales in situations where changing demand will best be captured through lower or higher prices. The restaurant can also populate their menu list through the system.

The restaurant and retailer can select to automatically or manually include “expert” or “recognized” guidance advice, programs and services such as nutrition programs, diet programs, allergen lists, food and beverage type lists, identified chefs, identified sommeliers, and identified customers in their food and beverage ordering presentation options and preferences. This information benefits customers by helping them simply and quickly identify food and beverage types that align with their identified needs. For example, if a user wants to subscribe to a diet program, they can chose to integrate this program into their ordering preferences to help them identify the best types of food and beverages at the restaurant or retailer they are visiting.

The restaurant and retailer can utilize numerous location identification mechanisms associated with ordering and serving food and beverages to identified locations and customers, and to help identify the location of food and beverages in floor or storage inventory for customers and employees. These identification mechanisms may include digital maps that are accessed through the host and remote application, digital location coordinate communication devices located in the restaurant or retailer that communicate to the remote and host application to identify the customer's location for ordering and serving and identify the location of a specific food or beverage in inventory, a customer or employee global positioning system (GPS) location identification that communicates to the remote and host application to identify the customers location for ordering and serving and identify the location of a specific food or beverage in inventory, signage located in restaurants and retailers that is associated with serving locations that can be entered into the remote application and shared with the host application to help employees identify where customer orders are placed and need to be delivered, and signage located in restaurants and retailers that is aligned with inventory location presented in the application to help customers and employees identify locations of food and beverages.

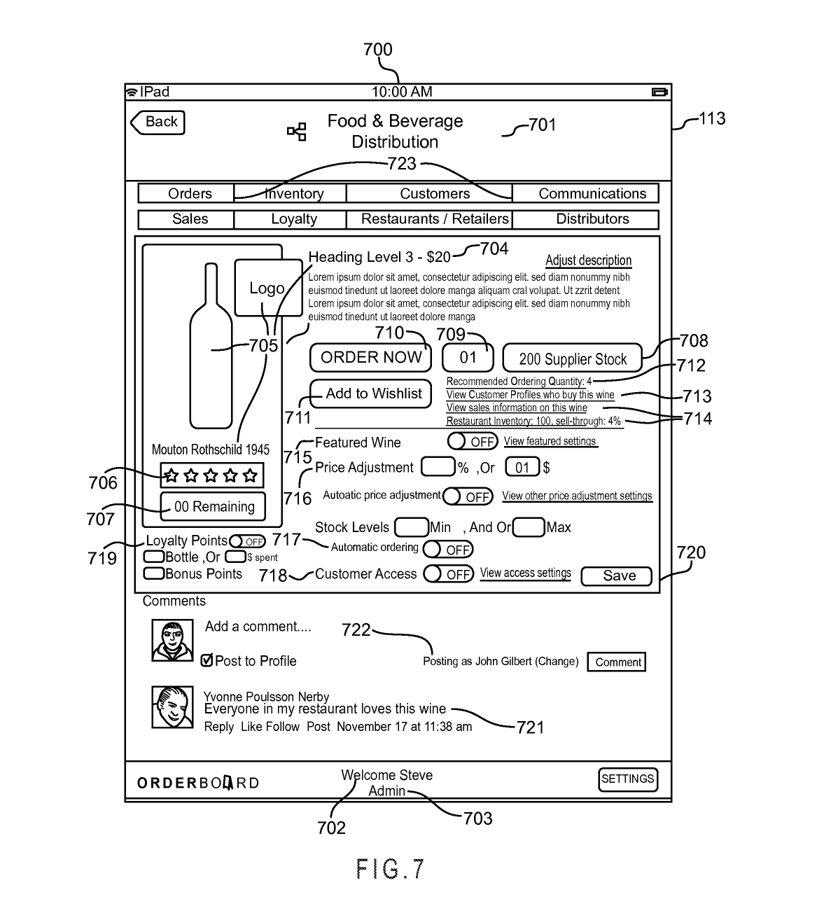

FIG. 7 shows a fifth embodiment of a user interface 700 implemented on a tablet computer 113. Here, the distributor can manage items in their inventory including description, featured settings, price adjustment settings, stock level settings, customer access settings, and loyalty point settings, as well as place orders from suppliers and adjust settings for the item being ordered, view content to help them better manage and order including recommended ordering quantities, customer profiles who buy this item, sales history of this item, and read and share comments about this food or beverage. This interface is customized for use by the distributor to manage and order inventory. As shown in FIG. 7, the interface 700 is fully customized so that the distributor's logo and name may be shown in the header 701 of the page. The distributor user (employee) can log in to the interface screen 700 and preferences and other information will be read from the user's account residing on the system 100 such as the memory 118 of the host computer 113A. Based on the user account information and preferences, the screen will be customized to display the user's name 702, and an account access level or responsibility designation 703. The system and method herein allow users the ability to customize their user interface based on a variety of factors to ensure that the user experience is helpful and efficient during the food or beverage inventory management and ordering process.

FIG. 7 also shows that the user account information will also inform the display of the interface 700 via the methods described further below. In this example, a selection of food or beverage 704 is displayed. Each food or beverage selected 704 will include information 705 on the selected food or beverage, such as an icon or photo, headline, description, review, or other information. Other information associated with the particular food or beverage 704 can also be displayed, such as the rating 706, local inventory level 707, or supplier inventory level 708, which can all be based on various factors described further herein. In association with the selected item 704 the user also has the ability to adjust order quantity 709, place the order 710, add the item to a wish list 711 for simple future references, view recommended ordering quantities 712, which can all be based on various sales, customer, inventory levels and other network tracked factors described further herein, view profiles of customers who buy this wine 713, view sales of this wine 714, select if it will be a featured wine 715 and view featured settings that include the ability to turn features on or off, bid on featured listing prioritization, select and adjust price adjustments 716 by percentage markup or dollar markup, select if the price will be automatically adjusted if supplier changes price, or view other price adjustment settings based on various factors such as geography, customer and quantity, select and adjust stock levels 717 including minimum and maximum inventory levels, and automatically order from a supplier based on various factors, select customer access 718 and adjust settings that include limiting sale of item to defined customer(s) based on characteristics such as a specific account, restaurant or retailer type, sales value, sales volume, food and beverage sold average value, and geography, select and adjust loyalty points 719 earned with the purchase including points earned by the purchase of the bottle or per dollar spent on the bottle, bonus points earned with the purchase of this bottle, and save 720 changes that were adjusted by user. Finally, a user can view other postings 721 about this food or beverage by other customers, distributors, suppliers, restaurants and retailers, or post their own comments 722.

Finally, as shown in FIG. 7, the interface 700 may include various navigational buttons and icons 723 to allow the user to manipulate the display, scroll or otherwise progress through pre-determined areas of the application such as Back, Home, Orders, Inventory, Sales, Customers, Communications, Loyalty, Distributors, Account, Settings, Ratings, etc.

A user interface for supplying beverages or food by a supplier is provided that includes a graphical identifier to allow a user of the interface to log into a user account associated with the supplier, and a screen showing a pre-determined selection of beverages or food, that could combine beverages or food pairings, beverages or food categories, customer demand, customer demographics, customer behavior, customer preferences (liked and not liked), customer rankings, customer experience and taste ratings; customer geographic proximities, customer geographic association to other geographic locations, restaurant and retailer demand, restaurant and retailer ratings and rankings, restaurant and retailer type, distributor demand, distributor ratings and rankings, and distributor type. Any or all of these elements could be manually adjusted or automatically presented to the supplier. These recommendations may be enhanced through neural network and artificial intelligence algorithms with proprietary variable settings across all captured data in the network including other customer, retailer, restaurant, distributor and supplier preferences and history. The manual or automatic recommendations can be utilized across the network or targeted to specific location(s). The benefit of this pre-determined selection of beverages or food for suppliers is a quicker, simpler and more effective method for determining offerings that align with customer (restaurants, retailers, distributors and customers) preferences. This can produce higher unit volume and revenues that align with customer demands and reduce costs associated with effectively supplying, managing inventory and supplying beverages or food that best align with customers' demands.

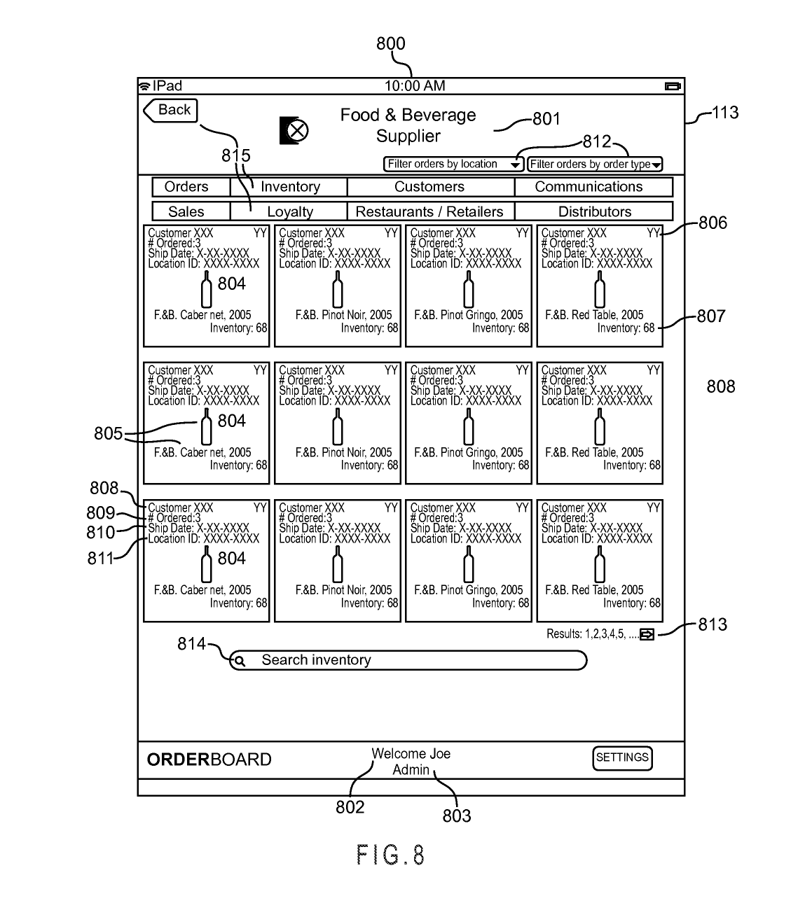

FIG. 8 shows a sixth embodiment of a user interface 800 running on a tablet computer 113. This interface is customized for use by a food and beverage supplier to manage orders that were made by distributors, retailers and restaurants similar to that shown in FIG. 6. Here, the supplier can manage orders, view its particular inventory of food and beverages, and make shipments to customers (the retailers, restaurants and distributors) via a customized set of icons. Similarly, FIG. 8 illustrates a user interface 800 customized for a supplier, wherein the tablet computer 113 may be used by the supplier to track orders, view inventory and make shipments. As shown in FIG. 8, the interface 800 is fully customized so that the supplier's logo and name may be shown in the header 801 of the page. The supplier user (employee) can log in to the interface screen 800 and preferences and other information will be read from the user's account residing on the system 100 such as the memory 118 of the host computer 113A. Based on the user account information and preferences, the screen is customized to display the user's name 802, and an account access level or responsibility designation 803. The system and method herein provides users the ability to customize their user interface based on a variety of factors to ensure that the user experience is helpful and efficient during the food or beverage ordering and inventory management process.

The user account information will also inform the display of the interface 800 via the methods described further below. In this example, a selection of food or beverage orders 804 is displayed. Each food or beverage order 804 includes information 805 on the food or beverage, such as an icon or photo, headline, description, or other information. Other information associated with the particular food or beverage order 804 can also be displayed, such as the order ID 806, inventory level 807, Customer name or ID 808, Quantity Ordered 809, Ship Date 810, and Location ID 811 that can be associated to the supplier's infrastructure or restaurant's, retailer's or distributor's defined geographic identifiers. Finally, the user can access search tools to filter 812 order results by geographic location, order type, order value, customer type, customer, product type, product value, sales rep location, sales rep, and product ID, and navigate 813 through results returned from the selected search criteria, or search suppliers inventory 814.

Finally, as shown in FIG. 8, the interface 800 may include various navigational buttons and icons 815 to allow the user to manipulate the display, scroll or otherwise progress through a pre-determined areas of the application such as Back, Home, Orders, Inventory, Sales, Customers, Communications, Loyalty, Distributors, Restaurants and Retailers, Account, Settings, Ratings, etc.

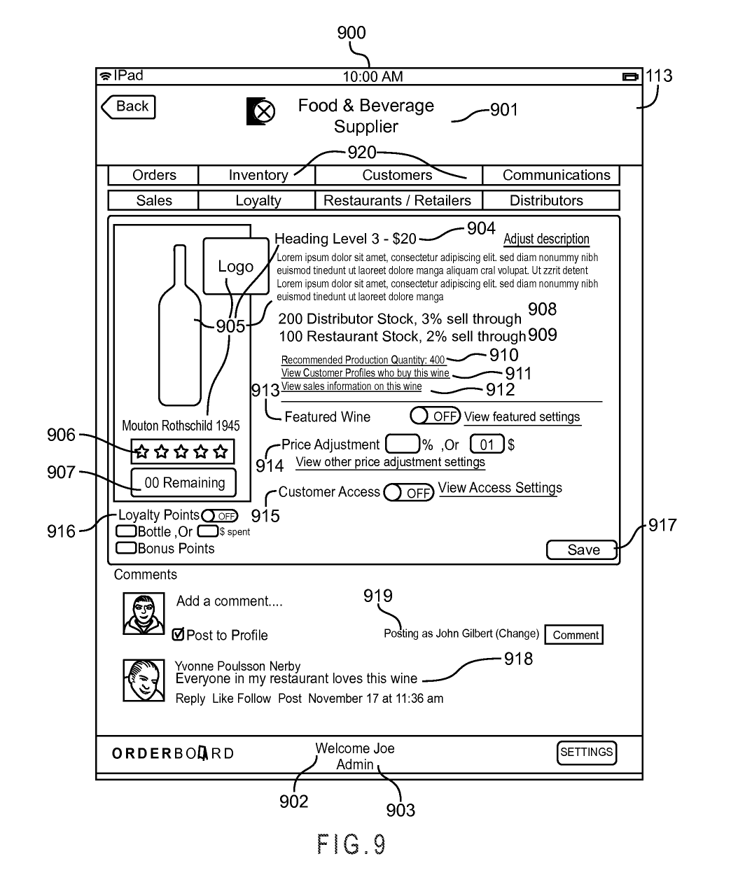

FIG. 9 shows a seventh embodiment of a user interface 900 implemented on a tablet computer 113. Here, the supplier can manage items in their inventory including description, featured settings, price adjustment settings, customer access settings, loyalty point settings, view content to help them better manage inventory including recommended future production quantitates, customer profiles who buy this item, sales history of this item, and read and share comments about this food or beverage. This interface is customized for use by the supplier to manage inventory. As shown in FIG. 9, the interface 900 is fully customized so that the supplier's logo and name may be shown in the header 901 of the page. The supplier user (employee) can log in to the interface screen 900 and preferences and other information will be read from the user's account residing on the system 100 such as the memory 118 of the host computer 113A. Based on the user account information and preferences, the screen is customized to display the user's name 902, and an account access level or responsibility designation 903. The system and method herein allows users the ability to customize their user interface based on a variety of factors to ensure that the user experience is helpful and efficient during the food or beverage inventory management process.

FIG. 9 also shows that the user account information will also inform the display of the interface 900 via the methods described further below. In this example, a selection of food or beverage 904 is displayed. Each food or beverage selected 904 will include information 905 on the selected food or beverage, such as an icon or photo, headline, description, review, or other information. Other information associated with the particular food or beverage 904 can also be displayed, such as the rating 906, inventory level 907, distributor inventory level 908 and sell through, and restaurant and retailer inventory level 909 and sell through. In association with the selected item 904 the user also has the ability to view recommended production quantities 910, which can all be based on various sales, customer, inventory levels and other network tracked factors, view customers profiles who buy this wine 911, view sales of this wine 912, select if it will be a featured wine 913 and view featured settings that include ability to turn features on or off, bid on featured listing prioritization, select and adjust price adjustments 914 by percentage markup or dollar markup, or view other price adjustment settings based on various factors such as geography, customer and quantity, select customer access 915 and adjust settings that include limiting sale of item to defined customer(s) based on characteristic such as a specific account, restaurant or retailer type, sales value, sales volume, food and beverage sold average value, and geography, and select and adjust loyalty points 916 earned with the purchase including points earned by the purchase of the bottle, per dollar spent on the bottle; and bonus points earned with the purchase of this bottle; and save 917 changes that were adjusted by user. Finally, a user can view other postings 918 about this food or beverage that may include customers, distributors, suppliers, or other restaurants and retailers; or post their own comments 919.

Finally, as shown in FIG. 9, the interface 900 may include various navigational buttons and icons 920 to allow the user to manipulate the display, scroll or otherwise progress through pre-determined areas of the application such as Back, Home, Orders, Inventory, Sales, Customers, Communications, Loyalty, Distributors, Restaurants and Retailers, Account, Settings, Ratings, etc.

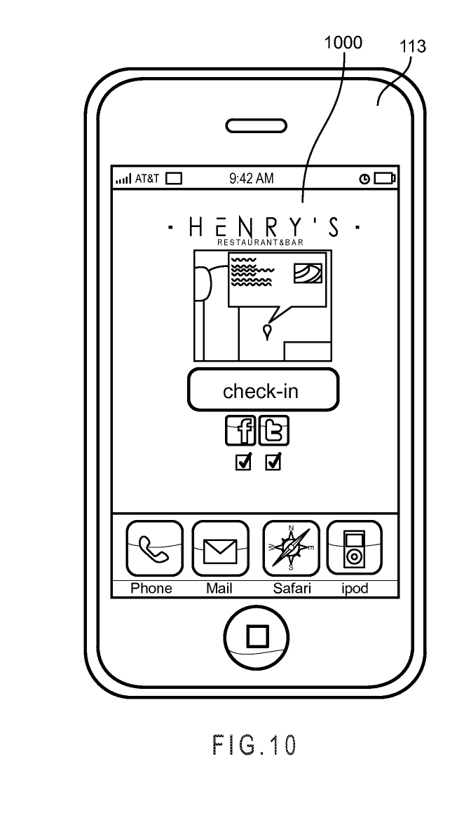

FIG. 10 illustrates the computer 113 as a handheld mobile device such as an Apple iPhone 4®. Here the user interface 1000 shows a customized check-in icon that allows users to “check in” using one or more social media applications. The interface 1000 may interact with the network 104 to allow the system 100 to implement user preferences, automatically log into food and beverage menus and perform other customized functions for the user.

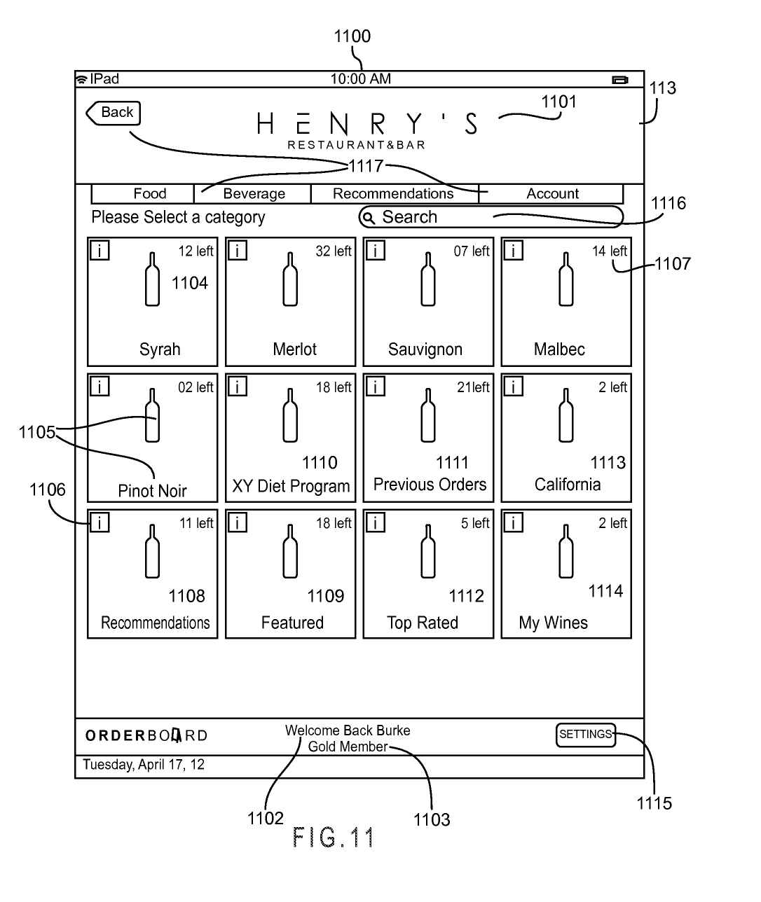

FIG. 11 shows another embodiment of a user interface 1100 implemented on a tablet computer 113. This interface is customized for use by the customer to help identify food and beverages to purchase from a restaurant, retailer, distributor, and supplier. As shown in FIG. 11, the interface 1100 is fully customized so that the restaurant, retailer, distributor or supplier logo and name may be shown in the header 1101 of the page. The user (customer) can log in to the interface screen 1100 and preferences and other information will be read from the user's account residing on the system 100 such as the memory 118 of the host computer 113A. Based on the user account information and preferences, the screen is customized to display the user's name 1102, and a membership level or ranking 1103. The system and method herein allows users the ability to customize their user interface based on a variety of factors to ensure that the user experience is helpful and efficient during the food or beverage search and purchase process.

FIG. 11 also shows that the user account information will also inform the display of the interface 1100 via the methods described further below. In this example, a selection of food or beverage categories 1104 is displayed. Each food or beverage category 1104 includes information 1105 on the food or beverage category, such as an icon or photo, headline, description, review, or in-depth information 1106. Other information associated with the particular food or beverage category 1104 can also be displayed, such as the inventory level 1107, which can all be based on various factors described further herein. The user also has the ability to add customized categories such as Recommendations 1108, Featured 1109, Diet/Nutrition program recommendations 1110, Previous Orders 1111, Top Rated 1112, Region 1113, My Wines 1114, Top Sellers, Best Trending, New Offerings, Sommelier Network Picks, Organics, etc. to the customized category displays. These customized adjustments can be accessed through the Settings button 1115. Finally, a user can search the retailer, restaurant, distributor or supplier stock 1116.

Finally, as shown in FIG. 11, the interface 1100 may include various navigational buttons and icons 1117 to allow the user to manipulate the display, scroll or otherwise progress through a pre-determined area of the application such as Back, Home, Orders, Food, Beverages, Communications, Loyalty, Account, Settings, Ratings, etc.

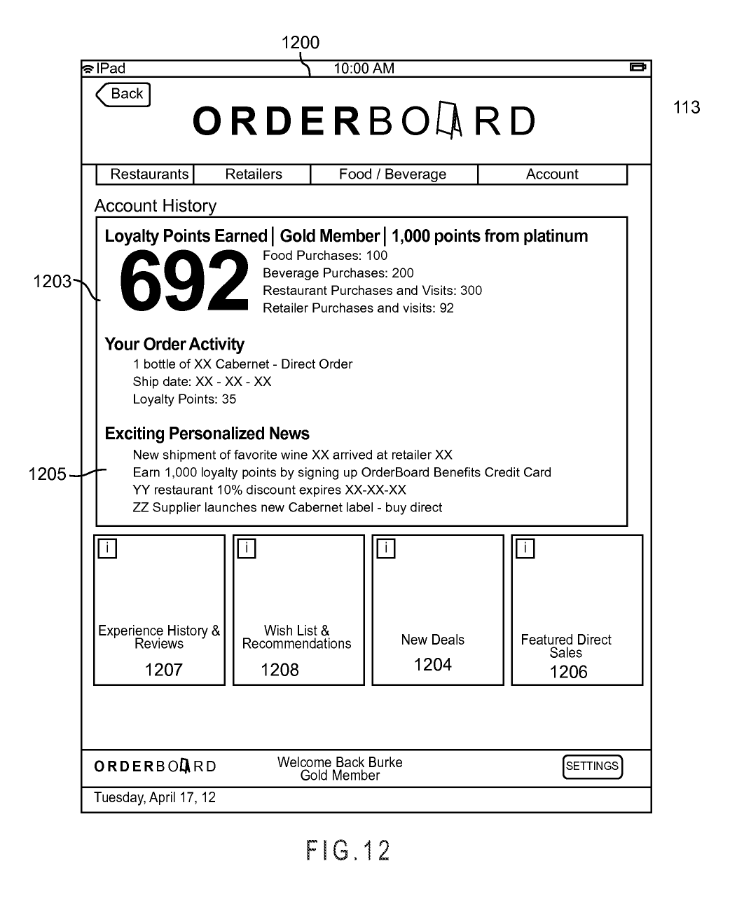

FIG. 12 illustrates a user account summary shown on a customized user account interface 1200, here implemented on a tablet computer 113. Here, various user account parameters for a particular user may be displayed, modified and reviewed by the user or others with authorized access. For example, the user's experience is customized as shown by the name 1201 and member level 1202. The user may be assigned a “loyalty” value using points or some other type of award, as shown at 1203. The method of awarding loyalty value within the system is an integral part of at least one embodiment of the invention herein, and will be described in more detail below.

As illustrated in FIG. 12, using the information associated with the particular user and stored in association with the user account, promotional information may be displayed such as New Deals 1204, Promotional News 1205, and Featured Direct Sales 1206. These suggestions are derived from a variety of data captured in the network (from restaurants, retailers, distributors, suppliers and other brands) and targeted according to user defined communication preferences and ratings, food and beverage sales history including volume and value, restaurant, retailer and supplier visit history, identified food and beverage preferences, food and beverage wish lists, geography, loyalty status and preferences, other customers in the network data and preferences such as the aforementioned targeting criteria. This targeted content and recommendation delivery may be enhanced through neural network and artificial intelligence algorithms with proprietary variable settings across all captured data in the network including other customer preferences and history.

Tracking information may also be displayed as shown in FIG. 12, for example, at 1207 and 1208, where previous food and beverage purchased, restaurants, retailers, and suppliers visited, and Wish Lists may be displayed. Furthermore, the user interface 1200 may provide the opportunity to enter or review ratings and comments relating to various restaurant, retailer and supplier visits, and food and beverage purchases. The user can also order foods and beverages from their user page. Moreover, the interface can also allow a user to input their payment information so that the user can be charged for the purchases. The user can also enter comments and tip amounts through the interface.

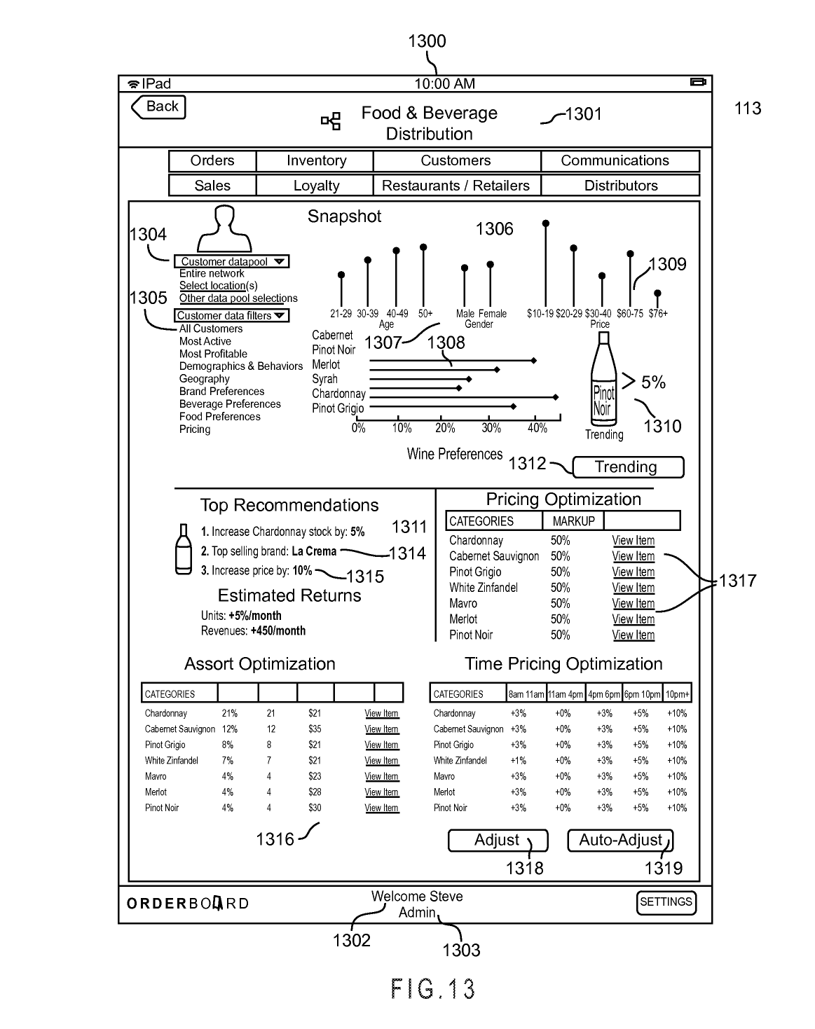

FIG. 13 shows a user customer information summary shown on a customized user account interface 1300, here implemented on a tablet computer 113. Here, various user account parameters for a particular user may be displayed, modified and reviewed by the user or others with authorized access. For example, the user's experience is customized as shown by the logo 1301, name 1302 and member level 1303. The interface user presents with a variety of customer research and recommendation tools to effectively better understand customer performances, identify customers, receive recommendations based on customer characteristics including sales history, behavior, demographics, food and beverage preferences, geography, brand preferences, pricing, and comparisons to other customer characteristics. These tools allow the user to make adjustments to a variety of factors including inventory levels, inventory assortment, inventory brand assortment, pricing and services to improve business performance based on the data. These recommendations may be enhanced through neural network and artificial intelligence algorithms with proprietary variable settings across all captured data in the network including other customer, retailer, restaurant, distributor and supplier preferences and history.

As illustrated in FIG. 13, using the information associated with the particular user and stored in association with the user account, customer research and recommendation tools may be displayed such as the ability to select a customer data pool 1304 that could include the entire network, identified locations (restaurants, retailers, suppliers), geography, food type purchased, beverage type purchased, brand purchased, restaurant type, restaurant value, retailer type, retailer value, loyalty value, customer value, and customer volume. This data tool may be further filtered by other customer data filters 1305 such as most active customers, most profitable customers, demographics and behaviors, geography, brand preferences, beverage preferences, food preferences, and pricing. After a user makes these customer data selections a variety of views are generated that are related to these selections. For example, if a user selects Entire Network and Most Active Customers depending on the type and access level of the user the data records presented may include a snapshot 1306 with Customer Demographics 1307, purchasing behavior 1308, product type sales, brand sales, pricing 1309, trending 1310, and performance recommendations 1311. Additional information on this selected Customer data set can be accessed through an option to view complete results 1312.

These Performance Recommendations are derived from a variety of data captured in the network (customers, restaurants, retailers, distributors, suppliers and other brands) including food and beverage sales and purchase history including volume and value, restaurant, retailer and supplier visit history, identified food and beverage preferences, food and beverage wish lists, geography, loyalty status and preferences, restaurant, retailer, distributor and supplier type, price, value, volume, and inventory, inventory levels, inventory type, inventory contents, inventory value, inventory sell-through, inventory time possessed, and other customers, restaurants, retailers, distributors and suppliers in the network such as those aforementioned criteria. These recommendation deliveries may be enhanced through neural network and artificial intelligence algorithms with proprietary variable settings across all captured data in the network or at specific location(s) including other customer, restaurant, retailer, distributor and supplier preferences and history. After these calculations are completed a data set is generated that is related to user selections 1304 and 1305 as shown in FIG. 13. For example, if a user selects Entire Network and Most Active Customers depending on type and access level of the user the data records presented may include Performance Recommendations 1311 with Top Recommendations 1314 that could include inventory adjustments, brands and pricing with estimated returns 1315, assortment optimization 1316 that includes inventory breakdowns, units, pricing and brands, and pricing optimization 1317 that includes markup, dollar value, timing, categories, and brands.

Finally, these performance recommendations can be applied to the respective user (restaurant, retailer, distributor and supplier) through manual adjustments 1318 or automatically as suggested 1319.

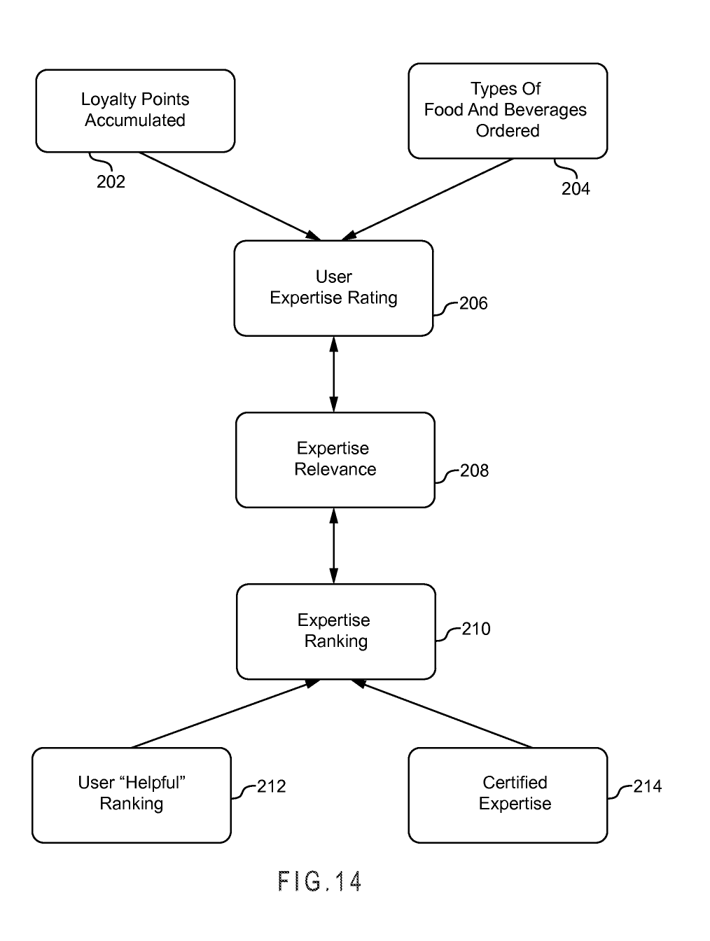

Using the system components and information displays described above in FIGS. 1-13, a first embodiment of a method for interfacing with participants in the system 100 is illustrated in the flow diagram of FIG. 14.

Individual users of the system 100 who purchase food or beverages often and contribute ratings may be “ranked” relative to other users. Such a ranking would allow the user's reviews of particular food and beverages to be shown higher up in a listing of reviews on the user interface screens. The rankings may be associated with loyalty value levels that relate to a particular user, but preferably such a ranking considers other factors. FIG. 14 illustrates such factors which contribute to the “expertise ranking” 210. The amount of loyalty points accumulated by the user, shown as 202, is one of the factors considered to arrive at a particular user expertise rating 206, along with the types of food and beverages purchased by that particular user. For example, if the user has ordered more sauterne wines than other users, or if the user has ordered enough wines to be considered relatively knowledgeable about sauternes, this may be considered when determining that particular user's expertise in association with those sauternes wines. The user expertise rating 206 may be made further relevant by the type of food or beverage being viewed by another user, hence the expertise relevance adjustment made at 208.

Finally, as shown in FIG. 14, the expertise ranking 210 may be further attenuated by other factors that may boost the ranking, such as being recognized by other users for providing “helpful” reviews 212, or getting a certification as to the reviewing user's particular food and beverage rating expertise 214.

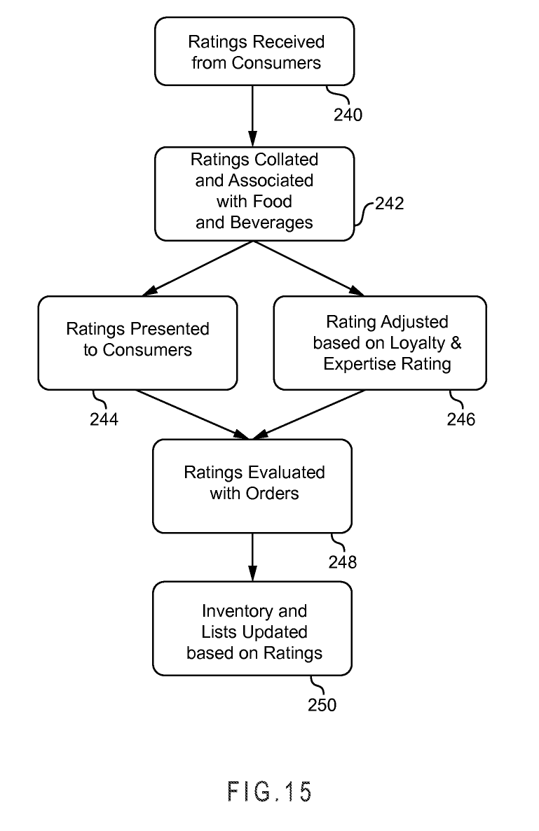

The various ratings made by users are collected, collated and associated with information attendant to individual food and beverages, as shown at 240 and 242 of FIG. 15. The collected ratings are then presented to users at 244, and as noted in conjunction with the method of FIG. 14, the particular ratings may also be attenuated or otherwise adjusted based on the loyalty and expertise rating of the individual user giving a particular ranking. For example, if a user with very little loyalty and only minor food or beverage-ordering experience (according to the system 100 information) gives a food or beverage a 5-star rating, the system may modify that ranking and adjust the 5-star rating downwardly to a 3.5-star rating given that reviewer's lower expertise rating.

Ratings for a particular food or beverage may also be attenuated or adjusted at 248 of FIG. 15, most likely upwardly, depending on more objective factors such as an increase in the number of orders placed for that food or beverage made to distributors and suppliers within the system 100. For example, if Distributor A receives three times as many bottles of a particular brand and vintage of merlot, that may earn that particular merlot higher ratings. Finally, food and beverage inventory both at distributors 103 A and B and in the local inventories of retailers 102 may be updated at 250 in accordance with demand, or anticipated demand, for a particular food or beverage as signaled by increases in ratings given for that food or beverage.

A method of awarding loyalty credit associated with at least one purchase of a consumable product such as beverages or food, visit to a restaurant or retailer, review of a consumable product, restaurant or retailer, communication (email, twitter, Facebook, or other communication and social vehicles) sharing a purchase of a consumable product or visit to a restaurant or retailer, referrals associated with a visit to retailer, restaurant or supplier or purchase of a consumable product within a network of restaurants, retailers, distributors and suppliers is also provided. The method includes recording the number of the visits to the restaurant or retailer, recording the number of consumable product purchases, the value of consumable product purchases, the number or consumable product and restaurant or retailer ratings associated with a visit or purchase of a consumable product, recording the number of communications sharing visits or purchases of a consumable product, and referrals linked to a visit or purchases associated with a user account, recording loyalty incentive promotions applicable to the user account, and calculating a loyalty credit value based on these parameters. The method also includes associating the loyalty credit with the user account for a predetermined time period. This loyalty credit may be extended through direct and indirect payment services such as credit cards, gift certificates, or direct credit applied within the network.

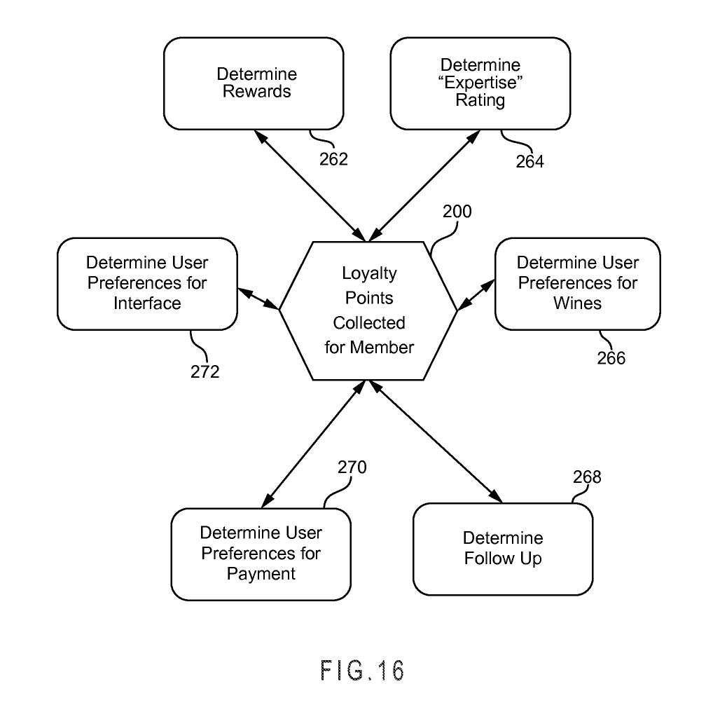

Members or users of the system 100 are preferably awarded loyalty credit as shown in FIG. 16. The loyalty value collected at 260, which may for example comprise a number of points accumulated by a particular user, may be awarded based on, or attenuated by, purchases of food or beverages made within the system 100, cash spent at restaurants 102, or other award methods. The loyalty credit that is collected can be used to modify other rankings within the system. For example, the amount of loyalty credit accumulated by a particular user may be used to determine that user's expertise rating at 264, as described above in connection with FIG. 14. Furthermore, the amount of loyalty credit may help determine the user's preferences for particular food and beverages, and custom recommendations can be made to that user. For example, if the user has a high amount of loyalty credit associated with merlots, the system 100 and the host computer 113 can recommend mostly merlots to that user via the user interface. The loyalty credit can also determine the amount of follow up that the user may find favorable at 268 regarding purchases, email solicitations for ordering cases of a favorite food or beverage, etc. The loyalty credit can also help determine the user's preferences for payment method 270, the preferences for the user interface 272, and offer particular rewards to the user 262, such as food or beverage or other incentives.

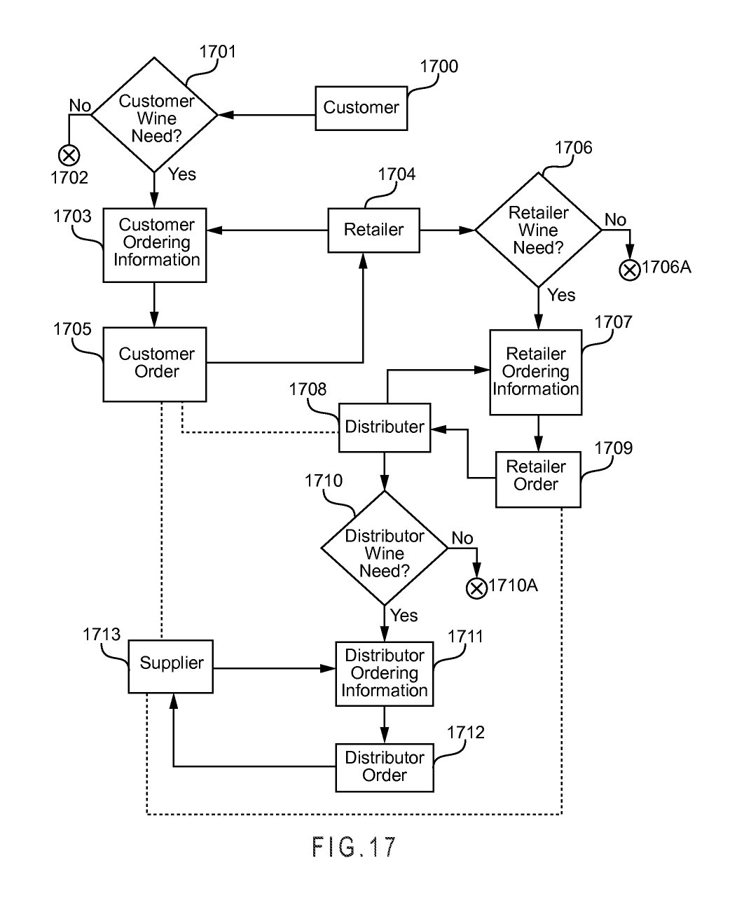

FIG. 17 illustrates the information flow and steps relating to the communication and information sharing between customers, retailers, distributors and suppliers. Wine ordering is shown as an example herein. As appreciated by one with the ordinary skill in the art, all food and beverage orders may be implemented in the same or similar manners.

As shown in FIG. 17, the first step for ordering the wine is to determine whether a customer 1700 has a need for the wine 1701. If there is no customer need for the wine, the data flow comes to an end 1702. However, when the customer 1700 needs the wine, he or she may access the customer ordering information 1703 and decide what to order. As shown in 1703 of FIG. 17, the customer ordering information 1703 may include, but not limited to, wine rankings, prices, availabilities, expert/other customer opinions, features of the wine, previous experience and loyalty points. FIG. 5 shows an example of a customer ordering information screen that may be displayed to a customer. The customer ordering information 1703 may be read from the customer's profile and/or system data storages. The customer ordering information 1703 may also be fed from a retailer 1704 and/or other resources such as social networks, postings on various websites, etc. The system generates the customer order which is to the retailer 1704. After the customer 1700 makes the ordering decision for the wine, alternatively is shown by dashed line in FIG. 17, the customer 1700 may directly communicate with distributors 1708 or suppliers 1713.

The retailer 1704, as shown in FIG. 17, may evaluate whether there is a need for wines 1706. If the wine is available in stock for the customer order 1705 or there are sufficient wines in stock to fulfill foreseeable customer orders, there is no need for the retailer 1704 to order wines. The data flow may end at this stage 1706A. However if necessary, the retailer 1704 may order wines to satisfy the current customer order 1705 or fulfill foreseeable customer orders. In the event wines are needed, the retailer 1704 may access the retailer ordering information 1707 and decide what to order. The retailer ordering information 1707 may include, but is not limited to, product descriptions, featured wines, prices, current inventories, loyalty points and customer preferences (liked and not liked). The retailer 1704 may also be provided with recommended ordering quantities, sales information and the profile of customers who buy wines. In addition, the retailer 1704 may access to distributors' stock information. The retailer ordering information 1707 may be read from customer's profiles and/or system data storages. It may also be fed from the distributor 1708, the customer 1700 and/or other resources such as social networks, and posting on various websites, etc. After the retailer makes the ordering decision for wines, the retail order 1709 may be generated and sent to the distributor 1708. Alternatively, as illustrated by dashed line in FIG. 17, the retailer 1704 may directly communicate with the supplier 1713.

Similarly, the distributor 1708 may evaluate whether there is a need for wines 1710. As shown in FIG. 17, if the wine is available in stock for the retailer order 1709 or there are sufficient wines in stock to fulfill foreseeable retailer orders, there is no need for the distributor 1708 to order wines. The data flow may end 1710A. However, the distributor 1708 may order wines to satisfy the retailer order 1709 or fulfill foreseeable retailer orders. In the event wines are needed, the distributor 1708 may access the distributor ordering information 1711 and decide what to order. The distributor ordering information 1711 may include, but is not limited to, product descriptions, featured wines, prices, current inventories, loyalty points and customer preferences (liked and not liked). System may provide the distributor 1708 with recommended ordering quantities, sales information, retail inventories and profiles of customers who buy wines. In addition, the distributor 1708 may access information resulting to a suppliers' stock. The distributor ordering information 1711 may be read from customer's profiles, retailer's profiles and/or system data storages. The system may also feed the distributor ordering information 1711 from the supplier 1713, the retailer 1704, the customer 1700 and/or other resources such as social networks, and posting on various websites, etc. The distributor order 1712 may be generated and sent to the supplier 1713 after the distributor makes the ordering decision for wines.

In yet another aspect of the invention, the system allows for restaurants, retailers, distributors and suppliers to effectively manage their customers through quantitative and qualitative data views that include sales, demand, demographics, behaviors, geographic location, reviews, trends, and preferences. The restaurant, retailer, distributor or supplier can then effectively communicate with their customers. The system includes reporting tools that provide a variety of different views of the customer that purchased the beverage and food within defined location(s), and across the entire network or restaurants, retailers, distributors, and suppliers. This information can be utilized by restaurants, retailers, distributors, and suppliers to better understand the customer purchasing the consumable product, gauge loyalty to the consumable product, and more effectively adjust their supply, distribution, sales, and pricing practices to more effectively produce and sell their respective consumable products to align with identified customer demand. This customer information can also be utilized by restaurants, retailers, distributors, suppliers and third-parties (such as brands) to target communications to customers based on their demographics, geographic locations, purchasing behavior and loyalty. The customer can also leverage this communication channel to directly communicate with an identified restaurant, retailer, distributor and supplier in regards to their experience and purchasing.

In yet another aspect of the invention the application that is utilized by customers, restaurants, retailers, distributors and suppliers can be implemented on a personal computer, personal digital assistant (“FDA”), a laptop, a smartphone, a cellular phone, a tablet, or other electronic device. The computer 113 may include an interface 114, software 16, memory 118, and a processor 120 so that a specific application on a particular handheld device need not be running separately. Thus, the interface and entire system may be interconnected via the Internet instead of an on-site wireless network.

In yet another aspect of the invention the system allows for automatic price adjustments within a location or across all parties in the network. For example, if the supplier raises prices, the distributor is notified of these price adjustments and can select to automatically or manually choose to change their respective inventory pricing to align with adjusted prices or maintain margin levels. If the distributor changes their price the restaurant or retailer selling the respective inventory will then be notified of the price adjustment and can select to automatically or manually change the price to reflect price adjustments or maintain margin levels. If the restaurant or retailer chooses to adjust the pricing of their inventory, they will have the option to automatically or manually adjust the pricing presented to customers to align with price adjustments or maintain margin levels. Any party in the system can change their respective inventory prices and where direct connections are made through the system and this price adjustment notification will occur and automatic price adjustment may be executed if activated according to identified criteria. This price adjustment links can be directly between a supplier and customer, a distributor and customer, a supplier and distributor, a supplier and retailer or restaurant. The system can also use pricing dynamics to allow the restaurants and distributors to maximize their margins through their pricing. This price adjustment system allows for more effective communication between parties and allows respective parties to more effectively manage their prices and margins.

In yet another aspect of the invention the system allows for automatic inventory adjustments within a location or across all parties in the network. For example, when a customer orders a minimum of one beverage or food unit from a restaurant or retailer, the restaurant or retailer inventory is automatically adjusted according to the respective beverage or food quantity reduction. If this updated inventory level is associated with an inventory quantity threshold trigger that may be manually or automatically produced through an inventory management notification and order setting selection by the restaurant or retailer, it may automatically send an inventory level notification or, if selected automatically, order an identified quantity of the respective food or beverage from an identified distributor or supplier. When a distributor receives a beverage or food order from a restaurant, retailer or customer, the distributor's inventory is automatically adjusted according to the respective beverage or food quantity reduction. If this updated inventory level is associated with an inventory quantity threshold trigger that may be manually or automatically produced through an inventory management notification and order setting selection by the distributor, it may automatically send an inventory level notification or if selected automatically order an identified quantity of the respective food or beverage from an identified supplier.

Furthermore, a customer can select to be notified or automatically order an identified quantity of units of food or beverage inventory from a restaurant, retailer, distributor or supplier if the respective party's inventory levels fall within an identified quantity threshold. A restaurant or retailer can also select to be notified or automatically order an identified quantity of units of food or beverage inventory from a distributor or supplier if the respective party's inventory levels fall within an identified quantity threshold. A distributor can also select to be notified or automatically order an identified quantity of units of food or beverage inventory from a supplier if the respective parties inventory levels fall within an identified quantity threshold. This automatic and dynamic inventory management system allows for more effective communication between parties and allows respective parties to more effectively manage their inventory positions, and be notified of food or beverage preferences that may be depleted in the near future.

In yet another aspect of the invention the restaurant, retailer, distributor or supplier can identify customer(s) and their respective food and beverage preferences including food and beverage brands, food and beverage types, desired price points, food and beverage pairings, and experience preferences. This includes sharing this information with restaurant and retailers front-of-house or back-of-house restaurant staff, and retailer's, distributor's and supplier's staff and customer service. This information may be accessed before an identified customer(s) visit or during a visit to help the respective party better serve their clientele. A customer may select to control their information privacy settings in respect to types of information that is shared with third-parties within the network.

In yet another aspect of the invention the restaurant and retailer can place simultaneous orders for multiple types of food and beverage through single or multiple distributors or suppliers. These orders can be automatically or manually generated through system inventory or ordering management settings. The benefit of this service is to reduce the time needed to place multiple orders across different parties.

In yet another aspect of the invention the restaurant, retailer, distributor, and supplier can feature identified items to the customer throughout various phases of the ordering and post-communication process. The featured products can be broadcast across the network or targeted to specific customer(s) based on attributes such as demographics, behaviors, purchases, visits, preferences, loyalty status, and location. They can also be targeted based on restaurant and retailer location, type and price range. These featured item listings can be manually or automatically controlled by the restaurant, retailer, distributor and supplier, or fully or partially controlled by system managers who have the option to charge a fee for priority of placement of these featured listings. The fee structure for priority of placement of these featured listings can be based on a variety of characteristics including customer lifetime value, customer demographics, customer purchasing history, customer average unit value, customer annual spending value, customer loyalty level, customer preferences, customer location, customer behavior retailer and restaurant sales, type and location; quantity of listings purchased value of listings purchased and time length of listings purchased. Restaurants, retailers, distributors, and suppliers who utilize this service will also have the option to integrate these featured item promotions with pricing and inventory controls that may align with their inventory quantities.

In yet another aspect of the invention, a user interface for ordering food or beverages by a restaurant, retailer, or distributor is provided including a graphical identifier allowing a user of the interface to log into a user account associated with the restaurant, retailer or distributor, as used as a screen showing a pre-determined selection of food or beverages, that could be a result of combining food or beverages pairings, food or beverage categories, customer demand, customer demographics, customer behavior, customer preferences (liked and not liked), customer rankings, customer experience and taste ratings, other restaurants and retailers with similarly identified customer preferences, customer demographics, customer behavior, customer geographic proximities, and customer geographic association to other geographic locations. Any or all of these elements could be manually adjusted or automatically provided to the restaurant, retailer and distributor. These recommendations may be enhanced through neural network and artificial intelligence algorithms with proprietary variable settings across all captured data in the network including other customer, retailer, restaurant, distributor and supplier preferences and history. The manual or automatic recommendations can be utilized across the network or targeted to specific location(s). The benefit of this pre-determined selection of beverage or food for restaurants, retailers and distributors is a quicker, simpler and more effective method for determining inventory assortments, inventory units, inventory pricing, preparations, and offerings aligning with respective restaurant, retailer and distributor clientele. This can produce higher unit volume and higher revenues by effectively aligning supply with targeted customer demands and therefore reducing costs associated with inefficient supply, storage & management of managing beverage or food inventories.

A customer's food and beverage purchasing preferences including a specific preferred food or beverage type or brand is recorded. If this identified food or beverage preference is available within an identified location(s) or across the network a notification will be presented to the customer to make them aware that this preferred food or beverage is available.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

What is claimed is:

1. A distribution system for distribution, inventory and sale of consumables, said system comprising:
a host operator, said host operator interfacing with a host computer including at least one user interface and at least one network interface, at least one memory, and at least one processor;
a plurality of distributors in communication with said host operator via a network, each of said plurality of distributors capable of assembling and transferring a quantity of consumables from one or more distributor inventories;
at least one supplier in communication with said host operator via said network, said at least one supplier capable of assembling and transferring a quantity of consumables from one or more supplier inventories;
a plurality of retailers in communication with said host operator via said network, each of said retailers implementing at least one terminal computer, each of said terminal computers including a user interface, at least one memory and at least one processor; and
software running on said host computer to allow said plurality of retailers to order quantities of consumable from said plurality of distributors and said at least one supplier via said user interface for transfer to said retailers.

2. The distribution system of claim 1 wherein said at least one terminal computer runs software comprising at least one application running on a mobile computing device.

3. The distribution system of claim 2 wherein said mobile computing device further comprises a tablet computer.

4. The distribution system of claim 1 wherein said software displays to the user of said terminal computer ratings associated with selected consumable types.

5. The distribution system of claim 4 wherein said software displays to the user of said terminal computer recommendations of selected consumable types based on input from said user of said terminal computer.

6. A user interface for ordering consumables by a consumer, said interface operating on a mobile graphical screen, said interface comprising:
a graphical identifier to allow a user of said interface to log into a user account associated with said consumer; and
a screen showing a pre-determined selection of consumables based upon user loyalty values, user experience ratings, ratings and restaurant or retailer type.

7. A user interface for inventory management of consumables, said interface operational on a tablet computer system, said interface comprising:
a graphical identifier to allow a user of said interface to log into a user account associated with said user; and
a screen showing a previously drafted order for a quantity of consumables, including at least one minimum order value, at least one consumable type, and a distributor from which said consumable will be ordered.

8. A method of ordering consumables from an on-site inventory local to a consumer via a graphical user interface and a network, said on-site inventory associated with at least one off-site inventory, said method comprising:
providing a user interface to a purchaser, said user interface capable of displaying at least a portion of said on-site inventory to said purchaser;
receiving instructions from said purchaser via said interface relating to the selection of a first consumable from said on-site inventory;
delivering said first consumable from said on-site inventory to said purchaser;
accounting for the cost of said first consumable with said purchaser;
determining whether said on-site inventory quantity of consumables of said first consumable is below a pre-determined minimum quantity; and
automatically generating a draft renewal order for transmittal to one or more pre-determined distributors of a sufficient quantity of consumables of said first consumable to replenish said on-site inventory quantity above said minimum.

9. The method of claim 8 further comprising awarding loyalty credit based on the cost of said first consumable.

10. The method of claim 9 further comprising requesting feedback information from said purchaser regarding said first consumable and receiving said feedback information from said purchaser.

11. The method of claim 10 further comprising associating said feedback with information relating to said first consumable and publishing said feedback to a plurality of user interfaces.

12. The method of claim 11 wherein said feedback is associated with said purchaser, and said feedback is given a value ranking based on a user expertise ranking.

13. The method of claim 12 wherein said user expertise ranking is based on the number of consumables previously selected by said purchaser for which feedback information was received from said purchaser.

14. The method of claim 8 further comprising transmitting said draft renewal order to one or more of said distributors.

15. The method of claim 8 wherein said distributors further comprises at least one supplier.

16. A method of awarding loyalty credit associated with at least one purchase of a consumable product such as wine within a network of retailers, said method comprising:
recording the number of said purchases of said consumable product associated with a user account;
recording product value ratings for each of said purchases based on said consumable products;
recording cost figures associated with said purchases associated with said user account;
recording the number of visits associated with said user account to said retailers within said network of retailers;
recording loyalty incentive promotions applicable to said user account;
calculating a loyalty credit value based on said number of purchases, said product value ratings, said cost figures, said number of visits and said loyalty incentive promotions for a predetermined time period; and
associating said loyalty credit with said user account for said predetermined time period.

17. The method of claim 16 wherein calculating a loyalty credit value further comprises adjusting said cost figures associated with said purchases based on said product value ratings.

18. The method of claim 17 wherein said loyalty incentive promotions further comprise multipliers to be applied to one or more of said product value ratings or cost figures associated with said user account.

19. The method of claim 16 wherein said loyalty credit value further comprises a number of points.

20. The method of claim 16 further comprising awarding a user expertise rating based on said loyalty credit value.

21. The method of claim 16 wherein at least a portion of said loyalty credit is transferable to more than one user account.

22. A method of modifying a user profile associated with a purchaser of consumable product such as wine within a network of retailers, said method comprising:
reading a loyalty credit value associated with said purchaser;
reading the types of consumable product purchased by said purchaser;
reading values relating to feedback about said purchaser from other users of said system;
reading information relating to certified expertise of said purchaser;
calculating a ranking value for said purchaser based on one or more of said loyalty credit value, said types of consumable product, said feedback values, and said information relating to certified expertise of said purchaser; and
associating said ranking with said user profile.

23. The method of claim 22 further comprising ranking said purchaser relative to a plurality of different users based on one or more of said loyalty credit, said expertise rating and said certification.

24. The method of claim 23 wherein said purchaser is associated with at least one product recommendation authored by said purchaser.

25. The method of claim 24 wherein ranking said user further comprises publishing said at least one product recommendation and ordering said at least one product recommendation at an appropriate level relative to product recommendations of other purchasers.
